(19) United States
(12) Patent Application Publication
(10) Pub. No.: US 2011/0005109 A1
(43) Pub. Date: Jan. 13, 2011

(54) INTERCHANGEABLE CONFECTIONARY DISPLAY SYSTEM

(76) Inventor: Mitch Junkins, Newport Beach, CA (US)

Correspondence Address: Rutan & Tucker, LLP., 611 ANTON BLVD, SUITE 1400, COSTA MESA, CA, 92626, US

(21) Appl. No.: 12/832,860

(22) Filed: Jul. 8, 2010

Related U.S. Application Data
(60) Provisional application No. 61/224,003, filed on Jul. 8, 2009.

(51) Int. Cl. B65D 8/00; G09F 1/00; B23P 17/04

(52) U.S. Cl. 40/124.06; 220/4.01; 493/84

(57) ABSTRACT

An apparatus and system for providing a personalized promotional item to an intended recipient is provided. The contemplated embodiments of the apparatus and system utilizes a confectionary to be sent, distributed or received by an individual whereby the confectionary may be personalized for each individual receiving party. Moreover, the system contemplates having a plurality of cavities to receive the promotional and personalized confectionary whereby the cavities may house the confectionary, and whereby the confectionary may be visible to the receiving party. Additionally, it is contemplated that the cavities be part of a visible portion whereby the portion may be adapted for attachment to a plurality of apparatus including greeting cards, promotional cards, business cards, magnetic devices and the like. It is further contemplated that the visible portion may be adapted to be interchangeable between a plurality of different adaptable devices, whereby the cavity may be open when the product is attached to any adaptable device such that confectionary may be retrieved and/or replaced as desired.

### PRIORITY CLAIM

This present application claims priority to the earlier filed U.S. Provisional Patent Application No. 61/224,003 filed on Jul. 8, 2009.

### FIELD OF THE INVENTION

The field of the invention is for advertising implements. More specifically, the field of invention is for an advertising sign that has interchangeable pieces.

### BACKGROUND

The history of advertising goes back for almost as long as human civilization. Advertising goes back centuries to when merchants would hang or prop wooden, stone, or other type of signs to advertise and/or describe their goods. Typically, these types of signs were crude and gave very limited information about the products and/or service offered by the merchant. Later in the evolution of advertising, merchants realized that the more elaborate and unique their signs were, the more business it might attract. Colors, symbols and other advertising means were incorporated along with other information that might grab the consumer's attention. Lighting and other colors were introduced that sought to bring greater attention to the merchant's product, even if the product was no more glamorous or different than the competitors in the market. Over time, new and inventive ways are utilized to advertise goods and services. Many current advertising methods use the internet, and electronic devices to directly communicate with the consumer in an effort to attract additional business. Commercial signs are used from freeway exits to internet websites. Any type of information that will attract the attention of a buyer is now used.

Advertising signs have the effect of increasing business revenue and sales results for many companies. The correlation between effective advertising and sale opportunity is well studied and well known. Effective signage can create a better visible business which may correlate with additional consumers and higher sales totals. Moreover, these types of marketing are direct to consumers because they are visible and may be highly personal.

Furthermore, advertising signs may allow a business the opportunity to advertise certain promotional programs, sales, give-a-ways, or other promotional material that may stimulate sales growth for that business. This type of direct marketing can be tailored to an individual consumer's preference, tastes and characteristics.

Additionally, physical promotional materials may be much more portable and viewable by those that come in contact with them.

However, a problem with most promotional material is that they are not completely personable to the individual user. For example, most promotional material is similar to what other individuals will likely receive, so the novelty of personalization is not evident.

Additionally, another problem that exists with personalize promotional material is that they are typically very expensive to make and distribute. Because each individual requires a different promotional product, the use of individual promotional materials increases the cost to make and distribute the promotional material exponentially.

Therefore, a need exists for a promotional material that may be easily modified and distributed to individuals.

Moreover, a further need exists for an efficient and inexpensive promotional material that may be personalized for each individual without the expense of personalizing the entire product. Further, a need exists for a confectionary promotional item which can be personalized to individual tastes, uses, and then re-used by simply attaching the promotional item with new confectionary to re-distribute with a personalized taste to another user.

### SUMMARY OF THE INVENTION

The present invention provides a system and a method for providing a promotional item that is personalized for a particular user. The contemplated embodiments of the system and method utilize a confectionary to be sent, distributed or received by an individual whereby the confectionary may be personalized for each individual receiving party. Moreover, the system contemplates having a plurality of cavities to receive the promotional and personalized confectionary whereby the cavities may house the confectionary and whereby the confectionary may be visible to the receiving party. Additionally, it is contemplated that the cavities be part of a visible portion whereby the portion may be adapted for attachment to a plurality of apparatus including greeting cards, promotional cards, business cards, magnetic devices and the like. It is further contemplated that the visible portion may be adapted to be interchangeable between a plurality of different adaptable devices whereby the cavity may be open when product is attached to any adaptable device such that confectionary may be retrieved and/or replaced as desired.

Among the many different possibilities contemplated, the apparatus may allow direct individualized gifts to be given to a specific recipient.

In an exemplary embodiment the present invention, an apparatus for personalized confectionary material comprising: a front portion having a plurality of convex and concave sections; said convex and concave section being constructed of a transparent material; and a cavity defined by the convex and concave sections whereby the cavity has at least an opening.

In an exemplary embodiment, wherein the said cavity is sized to accommodate a confectionary item.

In an exemplary embodiment, wherein said cavity has at least an opening whereby the opening accommodates the removal and insertion of a personalized confectionary item.

In an exemplary embodiment, wherein said front portion is adapted to be attached to a portable device such as a promotional card, business card, greeting card, envelope and a box.

In an exemplary embodiment, wherein said front portion may be affixed to a magnet whereby the entire apparatus may magnetically adaptable.

In an exemplary embodiment, wherein said front portion may be removed from a back portion which is temporarily attached and placed on another back portion for use.

In an exemplary embodiment, wherein said front portion is reusable.

In an exemplary embodiment, a method of assembling a personalize confectionary apparatus, the method comprising the steps of: providing a front portion having a plurality of convex sections; providing a back plate adapted to receive a front portion said convex sections being constructed of a transparent material; and said convex section of the front portion defining a cavity whereby the cavity is adapted to receive an object therein.

In an exemplary embodiment, further comprising the step of: inserting an object into the cavity and sealing the object within the cavity of the front portion.

In an exemplary embodiment, further inserting a confectionary item within the cavity and sealing the confectionary item in the cavity and shipping the front portion to an individual user.

In an exemplary embodiment, further providing at least an indent and an overlap portion on the back plate of the apparatus.

In an exemplary embodiment, further sliding the front portion of the apparatus into the indent portion of the back plate of the apparatus.

In an exemplary embodiment, further allowing for removal of the front portion of the apparatus from the back plate of the apparatus.

In an exemplary embodiment, further allowing the removal of an object from the cavity of the front portion by applying pressure to the convex section of the front portion.

Additionally, in an exemplary embodiment, the apparatus may utilize a plurality of parts including an insert portion.

In yet another exemplary embodiment, it is contemplated that the apparatus may utilize an insert portion wherein the insert portion may be adaptable for three-dimensional display capabilities.

In another exemplary embodiment, it is contemplated that the system may allow an individual to reuse at least a portion of the apparatus.

Another exemplary embodiment is to allow an individual user to interchange at least a portion of the apparatus including at least the insert.

A further exemplary embodiment contemplates that the apparatus may allow a visible portion of the apparatus to be seen by the specified recipient.

Further, a contemplated embodiment of the apparatus may be the inclusion of plurality of cavities in a visible portion of the apparatus.

Additionally, in an exemplary embodiment, the apparatus may provide for a plurality of cavities which are sized and shaped to house a plurality of confectionary items therein.

A further exemplary embodiment of the present invention may include a plurality of cavities which are sized and shaped to hold a plurality of personalize confectionary items therein.

In another exemplary embodiment, it is contemplated that the apparatus may have a plurality of cavities which are sized and shaped to hold a plurality of personalized confectionary items wherein the cavities are constructed of a suitably transparent material whereby the material may allow the individual recipient to view the contents of the cavities.

In another exemplary embodiment, it is contemplated that the apparatus may be constructed of a plurality of different materials, or may be constructed of a singular material.

Still another exemplary embodiment is to provide an apparatus for the display of personalized confectionary items, whereby the apparatus is constructed of plastic.

Yet another exemplary embodiment is to provide an apparatus for display of a personalized confectionary item whereby the apparatus may have a plurality of cavities constructed of at least a transparent material whereby the enclosed confectionary item may be visible by an ordinary observer.

In another exemplary embodiment, a display apparatus is provided for displaying a personalized confectionary item whereby the apparatus may have at least a plurality of cavities to display the confectionary item and a holder to hold the apparatus to another device such as a card, business card, box, bag, cup, and the like.

It is further contemplated that the apparatus may have at least a magnetic portion whereby the magnetic portion may be connected to the apparatus to allow the enclosed confectionary device to be displayed while being hung utilizing the magnetic portion.

Still another exemplary embodiment is to provide an apparatus for display of a personalize confectionary item whereby the apparatus may be re-used after initial use whereby the cavity may be emptied of its contents and refilled by new confectionary items after use thereby allowing the entire apparatus to be reused multiple times yet still retain its personalized nature.

In still another exemplary embodiment, an apparatus for display of a confectionary item is provided whereby the apparatus may be a Christmas ornament.

Yet another exemplary embodiment is to provide a personalize confectionary apparatus whereby the apparatus may have a connection means thereon to hang it from another surface whereby the connection means may be hangers, hook and fasteners, adhesives and the like.

In still another exemplary embodiment, an apparatus for display of a confectionary item is provided whereby the apparatus may be in the form of a luggage tag.

In another exemplary embodiment, an apparatus for display of a confectionary item is provided whereby the apparatus may be in the form of a piece of art wherein the apparatus may be framed and hung for a period of time.

Another exemplary embodiment of the present invention is to provide an apparatus for personalized gifting whereby the apparatus has at least a front portion which is visible to a recipient whereby the front portion is constructed of plastic.

In yet another exemplary embodiment, an apparatus for personalized gifting is provided whereby the apparatus includes a front portion which may be constructed of any suitable semi-rigid material and whereby a plurality of confectionary are visible to the individual recipient.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a perspective view of the invention illustrating the personalized item in an exemplary embodiment of the present invention;

FIG. 2 is another perspective view of the invention illustrating the personalized item including the confectionary and a card in an exemplary embodiment of the present invention;

FIG. 3 is a back view of an exemplary embodiment of the present invention;

FIG. 4 is a perspective view of the front portion and the back plate in an exemplary embodiment of the present invention;

FIG. 4B is a perspective view of an alternative back plate in an exemplary embodiment of the present invention; and

FIG. 5 is a back view of the front portion in an exemplary embodiment of the present invention.

### DETAILED DESCRIPTION OF THE INVENTION

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

In the following description, numerous specific details are set forth, such as examples of specific promotional materials and design configurations, etc., in order to provide a thorough understanding of the present invention. It will be apparent, however, to one of ordinary skill in the art that the present invention may be practiced without these specific details. In other instances, well-known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

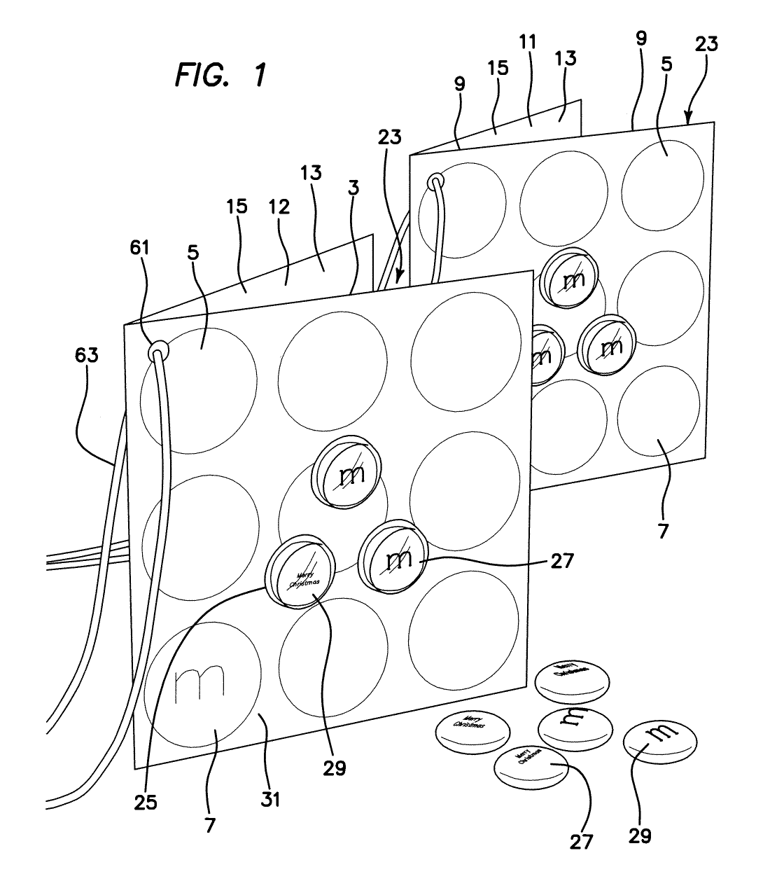

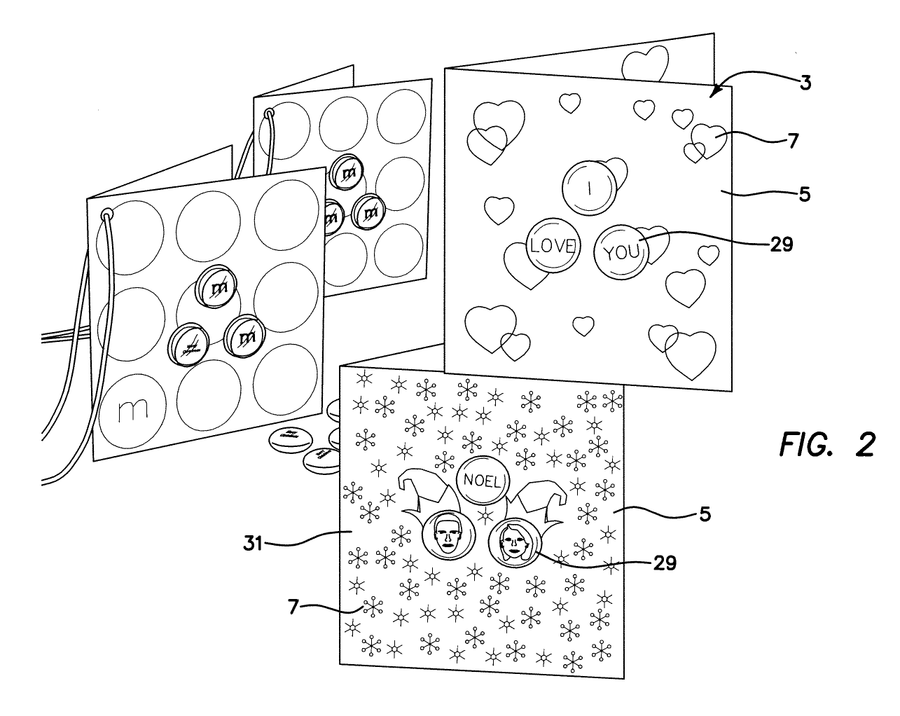

Referring to the figures, FIG. 1 illustrates the interchangeable personalized promotional system 1. FIG. 1 illustrates the promotional apparatus 1 having at least a back plate 3 and a front portion 5. In an exemplary embodiment, the back plate 3 may be generally planar. However, it should be understood that any shape or surface may be utilized to comprise a back plate 3. It is also contemplated that the back plate 3 may contain any number of indicia 7 thereon including advertising, promotional information, message information, words, slogans, names, designs, drawings, pictures, and/or any other type of graphical, word or pictorial information. Additionally, it should be understood that the indicia 7 contained thereon may be customized with messages and information specific for occasions such as Christmas, birthdays, anniversaries, or for encouragement including graduations, hospital visits and the like. FIG. 2 illustrates different back plates 3 having different indicia 7 thereon.

FIG. 1 further illustrates that the back plate 3 may be incorporated into a card like structure 9 whereby the back plate 3 may be removably connected to a second back portion 11 which may be left blank for customization and personalization by someone giving the personalized promotional apparatus 1. The second back portion 11 may have at least a first side 13 and a second side 15 whereby the first side may come in contact with the back side 17 of the back plate 3. It is contemplated that when folded, the first side 13 of the second back portion 11 may be obscured and not visible until the back plate 3 is separated from the second back portion 11 to review information that may be contained on the first side 13 of the second back portion 11. However, it should be understood that any configuration is contemplated that may allow for display of a promotional item on the front portion 5. Therefore the back plate 3 may be planar, curved, or incorporated into any manner of items including boxes, packages, frames, cards, signs, cups business cards and the like. For illustrative purposes, and for purposes of explaining the invention, in an exemplary embodiment, a card like apparatus is disclosed which includes the second back portion 11 having a blank space for customization and personalized notes to be inserted into the second back portion.

The front portion 5 may have a front side 31 and a back side 23. The back side 23 of the front portion 5 may be adapted to be connected to the back plate 3 of the apparatus 1. In an exemplary embodiment, it is contemplated that the back side 23 of the front portion 5 is affixed to the back plate 3 by using an adhesive. However, other connection means may be employed such as a staple, friction, hook and loop, fasteners, or snap fit. It is also contemplated that the front portion 5 may be detached from the back plate 3 and utilized with another back plate (see FIG. 2). By this faction, the front portion 5 may be constructed separate from the back plate 3 and may be adapted to fit any number of back plates 3. The ability to remove and detach the front portion 5 from the back plate 3 may allow the individual user of the apparatus 1 to utilize the front portion 5 with any number of back plates 3 having different indicia 7 thereon. The indicia 7 may present different holidays, occasions, celebrations or customized information thereon for use as desired by the individual user. Therefore, the front portion 5 may be constructed for use with any customized back plates 3 and presented to another individual.

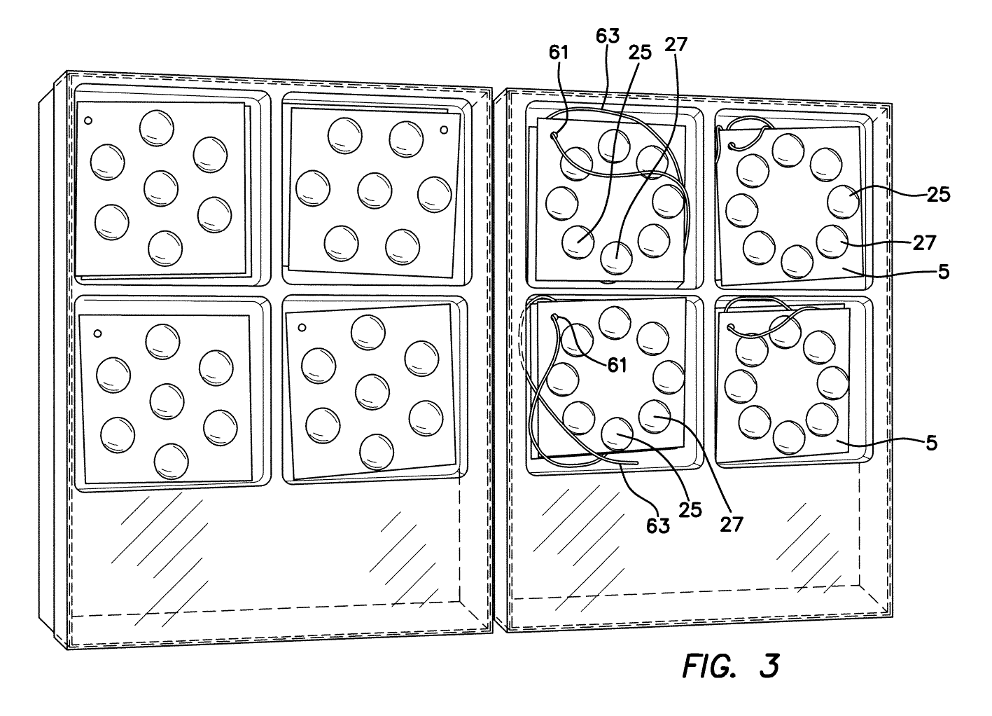

As further illustrated by FIGS. 1 and 3, the front portion 5 may have at least a convex surface 25 on the front side 31 which may define a space 27 between the front portion 5 and the back plate 3. The space 27 may be adapted to fit any type of item. However, for illustrative purposes a confectionary item is disclosed. In an embodiment, the convex surface 25 may provide the space 27 which may be adapted to fit a confectionary item 29, such as candy. It is contemplated that the space 27 be adequately sufficient to fit the confectionary item 29 such that the confectionary item 29 may be placed in the space 27 prior to enclosing the space 27 before the individual user accesses the front portion 5. The front portion 5 further includes a back side 23 which, as previously enumerated, may be configured to be adjacent to the back plate 3 of the apparatus. The back side 23 may be constructed of the same material as the front portion 5, or in an exemplary embodiment, may be constructed of a different material than the front portion 5.

The front portion 5 is preferably constructed of a resilient material such as plastic. However, any type of material may be utilized which is sufficiently resilient in nature. It is also contemplated that the convex surface 25 be constructed of an opaque and/or transparent material such that the contents of the space 27 be readily viewable by an individual user. The back side 23 of the front portion 5 of the apparatus 1 is preferably constructed of a less resilient material such as paper, cotton, thin aluminum and/or thin plastic. By utilizing a less resilient and more permeable material, the contents of the space 27 may be ejected through the material on the back side 23 of the front portion 5 and utilized by the individual recipient of the apparatus 1. For example, if a confectionary item 29 is contained within the space 27 on the front portion 5 of the apparatus 1, the individual user may forcibly press on the convex surface 25 which may cause the confectionary item 29 to push against the back side 23 of the front portion 5. The pressure of the confectionary item 29 against the permeable back side 23 material may cause the confectionary item 29 to push through, tear or split the permeable material on the back side 23 and eject the confectionary item 29 from the space 27. The confectionary item 29 may then be consumed by the recipient of the apparatus 1.

FIGS. 1-3 illustrate the convex surface 25 on the front portion 5 of the apparatus 1. However, it should be understood that the surface may be shaped, sized and configured to be adaptable to any number of items to be enclosed in the space 27. Although confectionary items 29 are disclosed, toys, novelty items and other types of goods may be contained within the space 27 on the front portion 5 of the apparatus 1. Additionally, the space 27 may be provided to accommodate any size and shaped object to be inserted and may also be configured to allow for pressure to be applied to eject the object from the space 27.

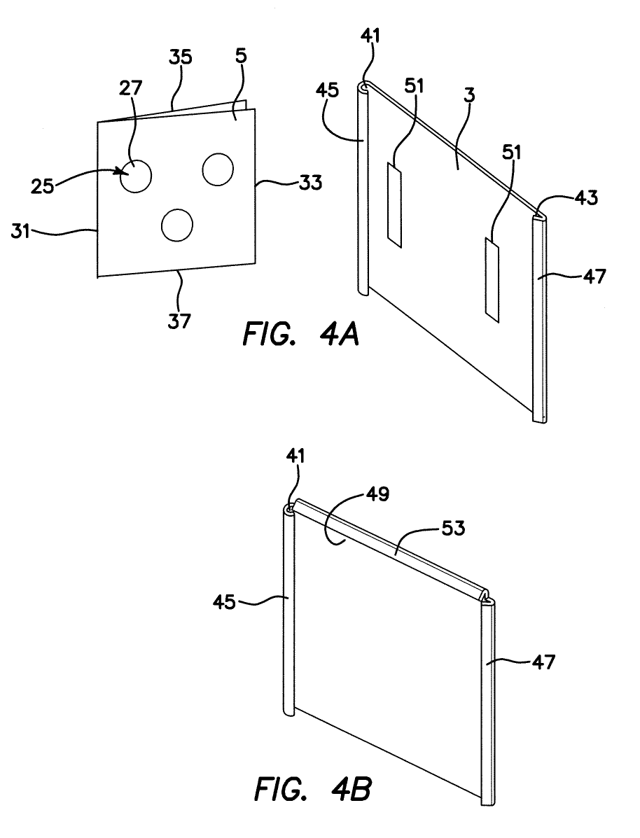

FIG. 4 illustrates the front portion 5 separated from the back plate 3. As illustrated previously, it is sometime desirous for the front portion 5 to be adapted to the back plate 3, yet be removable from the back plate 3 when desired to be place in another, separate back plate 3. FIG. 4 illustrates one exemplary embodiment on how to do so. In an embodiment, the front portion 5 has a first end 31, a second end 33, a third end 35 and a fourth end 37. The first end 31 and second end 33 being parallel to one another, while the third end 35 and fourth end 37 also being parallel to one another. The front portion also illustrates the convex surface 25 and the space 27 provided by the convex surface 25 extending away from the back side 23 of the front portion 5. The back plate 3, in an exemplary embodiment, may have a first indent 41 and a second indent 43 adapted to fit at least the first end 31 and the second end 33 of the front portion 5. Additionally, the back plate 3 may also have a first overlap 45 and a second overlap 47 which may secure the first end 31 and the second end 33 of the front portion 5 into the indents 41, 43 and secure the front portion 5 in place against the back plate 3.

It is contemplated that a securable adhesive 51 may also be provided on the back plate 3 to allow proper securement of the front portion 5 of the apparatus 1 to the back plate 3, and may prevent movement of the front portion 5 within the back plate 3. However, it is also contemplated that a third indent and a fourth indent (not shown) may also be provided on the back plate 3 in lieu of the securable adhesive 51.

In an embodiment, the first end 31 and the second end 33 of the front portion 5 may be slid into the first indent 41 and the second indent 43 of the back plate 3 to secure the front portion 5 within the back plate 3. However, it is also contemplated that the back plate 3 is constructed of a malleable material such that the back plate 3 may be bent to allow insertion of the first end 31 and the second end 33 of the front portion 5 into the first and second indents 41, 43 of the back plate 3. As illustrated in FIG. 4B, in another exemplary embodiment, a third indent 49 may also be provided, such that the front portion 5 may be slid into the first indent 41, second indent 43 and the third indent 49. The third indent 49 may also have a corresponding overlap 53 which may secure the third end 35 of the front portion 5 to the back plate 3.

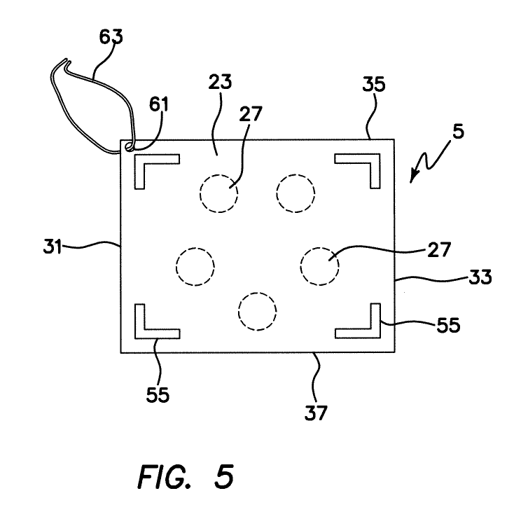

FIG. 5 illustrates the back side of the front portion 5. In an exemplary embodiment, the front portion 5 may have a back side 23 which is permeable to allow for pressure to be placed on the convex surface 25 and the space 27 to push an article from within the space 27 out the back side 23 of the front portion 5. It should also be understood that the front portion 5 may be a standalone product or may be associated with many other type products. For example, the front portion 5 may have a magnetic mechanism 55 associated therewith whereby the magnetic mechanism 55 may be secured to a portion of the back side 23 which does not interfere with the ejection of the article contained within the space 27. The magnetic mechanism 55 may allow the entirety of the front portion 5 to be displayed when the magnetic mechanism 55 is in contact with a metallic surface. For example, the entirety of the front portion 5 may be attached to a fridge, cabinet, or other metallic device for display of the article, or the front portion 5 itself. As illustrated earlier, the front portion 5 may have indicia 7 thereon that may be customized for an individual receiver of the front portion 5. It may also be utilized as decoration and may have a loop 61 associated therewith (see FIG. 1). The loop 61 may allow for a cord 63 to be thread through the loop and the cord 63 may be associated with any number of things, such as a hook on a wall, a keychain and the like. In another exemplary embodiment, as the indicia 7 may be customized for occasions, the front portion 5 may have a Christmas motive and the cord 63 associated with the front portion 5 may be hung on a Christmas tree (not shown) and utilized in a similar fashion as a Christmas ornament. In an exemplary embodiment, a plurality of convex surfaces 25 may be provided whereby an occasion or countdown may be utilized in association with the front portion 5. For example, with respect to utilizing the customized front portion 5 with the Christmas holiday, or Hanukah, the plurality of convex surfaces 25 including space 27 for a plurality of confectionary items 29 may be provided. For Hanukah, the significance of seven days may be illustrated by the apparatus 1 whereby for Christmas, twenty five convex surfaces 25 may be provided to count down the number of days until Christmas day.

The skilled artisan will recognize the interchangeability of various features from different embodiments. Similarly, the various features and steps discussed above, as well as other known equivalents for each such feature or step, can be mixed and matched by one of ordinary skill in this art to perform compositions or methods in accordance with principles described herein. Although the disclosure has been provided in the context of certain embodiments and examples, it will be understood by those skilled in the art that the disclosure extends beyond the specifically described embodiments to other alternative embodiments and/or uses and obvious modifications and equivalents thereof. Accordingly, the disclosure is not intended to be limited by the specific disclosures of embodiments herein.

I claim:

1. A apparatus for personalized confectionary material, the apparatus comprising:
a front portion having a plurality of convex and concave sections;
said convex and concave section being constructed of a transparent material; and
a cavity defined by the convex and concave sections whereby the cavity has at least an opening.

2. The apparatus described in claim 1 wherein the said cavity is sized to accommodate a confectionary item.

3. The apparatus described in claim 1 wherein said cavity has at least an opening whereby the opening accommodates the removal and insertion of a personalized confectionary item.

4. The apparatus described in claim 1 wherein said front portion is adapted to be attached to a portable device such as a promotional card, business card, greeting card, envelope and a box.

5. The apparatus described in claim 1 wherein said front portion may be affixed to a magnet whereby the entire apparatus may magnetically adaptable.

6. The apparatus described in claim 1 wherein said front portion may be removed from a back portion which is temporarily attached and placed on another back portion for use.

7. The apparatus described in claim 1 wherein said front portion is reusable.

8. A method of assembling a personalize confectionary apparatus, the method comprising the steps of:
providing a front portion having a plurality of convex sections;
providing a back plate adapted to receive a front portion
said convex sections being constructed of a transparent material; and
said convex section of the front portion defining a cavity whereby the cavity is adapted to receive an object therein.

9. The method of claim 8 further comprising the step of:
inserting an object into the cavity and sealing the object within the cavity of the front portion.

10. The method of claim 8 further comprising the step of:
inserting a confectionary item within the cavity and sealing the confectionary item in the cavity and shipping the front portion to an individual user.

11. The method of claim 8 further comprising the step of:
providing at least an indent and an overlap portion on the back plate of the apparatus.

12. The method of claim 11 further comprising to the step of:
sliding the front portion of the apparatus into the indent portion of the back plate of the apparatus.

13. The method of claim 8 further comprising the step of:
allowing for removal of the front portion of the apparatus from the back plate of the apparatus.

14. The method of claim 8 further comprising the step of:
allowing the removal of an object from the cavity of the front portion by applying pressure to the convex section of the front portion.
